(19) United States
(12) Patent Application Publication
(10) Pub. No.: US 2016/0266808 A1
(43) Pub. Date: Sep. 15, 2016

(54) INFORMATION PROCESSING DEVICE, INFORMATION PROCESSING METHOD, AND RECORDING MEDIUM

(71) Applicant: FUJITSU LIMITED, Kawasaki-shi (JP)

(72) Inventors: Masato Yamaguchi, Tsu (JP); Yasunori Taniguchi, Kobe (JP); Tsuyoshi Adachi, Kobe (JP); Yurie Enomoto, Akashi (JP)

(73) Assignee: FUJITSU LIMITED, Kawasaki-shi (JP)

(21) Appl. No.: 15/157,514

(22) Filed: May 18, 2016

Related U.S. Application Data
(63) Continuation of application No. PCT/JP2013/081444, filed on Nov. 21, 2013.

(51) Int. Cl. G06F 3/06

(52) U.S. Cl. CPC G06F 3/065; G06F 3/0619; G06F 3/0683

(57) ABSTRACT

A non-transitory computer-readable recording medium storing therein a backup control program that causes a computer to execute a process comprising: detecting storage access load and processor load of a target computer, the storage access load being a load of access to a storage of the target computer, and the processor load being a load on a target processor of the target computer; determining a data volume of backup processing based on the storage access load and the processor load, the backup processing accompanying access to the storage and operation of the target processor; and performing the backup processing based on the data volume.

### CROSS-REFERENCE TO RELATED APPLICATION

This application is a continuation application of International Application, No. PCT/JP2013/081444, filed Nov. 21, 2013, the disclosure of which is incorporated herein by reference in its entirely.

### FIELD

The embodiments discussed herein are related to an information processing device, an information processing method, and a recording medium.

### BACKGROUND

What is referred to as backup updating, in which incremental updates to database data are stored in storage, is known for backup of database data. Backups of database data that include updating a backup generally place a significant load on computer systems during execution of business processing. Accordingly, in cases in which backing up is performed in a time period in which business processing accompanying database access is being executed, there is a significant impact on execution of business processing. Backing up database data is therefore generally performed by, for example, an operation that executes as batch processing within a time period in which business processing is not being executed, or a time period in which the load accompanying execution of business processing is comparatively low (for example, at night), as illustrated in FIG. 17.

When the time period in which backing up is performed is separated from the execution time period of business processing, and backing up is performed in an intensive manner, the load placed on the computer system is particularly large in the duration over which backing up is performed, as illustrated in FIG. 17. There is therefore a need to even out the load placed on the computer system accompanying backing up. There is also a need to perform an operation to set an execution start timing or the like for backup processing when backing up is performed as batch processing within a particular time period.

In relation to the above, a first technology has been proposed that instructs execution of backup processing when it has been inferred that work by an operator is suspended based on operation input by the operator being interrupted, or CPU load or communications load reaching a specific level or below. The first technology instructs suspension of backup processing when it has been inferred that work by the operator has resumed.

A second technology has also been proposed in which backup processing is performed for a particular time using a low load I/O path when data access load is low, and backup processing is temporarily suspended when data access load is high. The second technology monitors whether backup processing is being performed on data during update processing, and when backup processing is detected, temporarily suspends backup processing, and then resumes the backup processing after the data update has completed. Related Patent Documents

Japanese Patent Application Laid-Open (JP-A) No. 2005-346218 JP-A No. 2010-26830

### SUMMARY

According to an aspect of the embodiments, a non-transitory computer-readable recording medium storing therein a backup control program that causes a computer to execute a process comprising: detecting storage access load and processor load of a target computer, the storage access load being a load of access to a storage of the target computer, and the processor load being a load on a target processor of the target computer; determining a data volume of backup processing based on the storage access load and the processor load, the backup processing accompanying access to the storage and operation of the target processor; and performing the backup processing based on the data volume.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a schematic configuration of a DB server according to an exemplary embodiment;

FIG. 2 is a functional block diagram illustrating an example of a computer that functions as a DB server;

FIG. 3 is a schematic diagram illustrating execution of processing related to a CPU and processing related to I/O, accompanying execution of an application or input of a command in a DB server;

FIG. 4 is a conceptual diagram schematically illustrating processing according to technology disclosed herein, amongst processing executed by a DB server;

FIG. 5 is a flowchart illustrating CPU processing result recording processing;

FIG. 6 is a table illustrating an example of CPU processing result information;

FIG. 7 is an illustrative diagram and a table for explaining collection of processing result information related to I/O;

FIG. 8 is a flowchart illustrating processing related to I/O;

FIG. 9 is an illustrative diagram and a table illustrating an example of storage and configuration management information;

FIG. 10 is a flowchart illustrating load monitoring processing;

FIG. 11 illustrates tables for explaining load monitoring processing;

FIG. 12 is an explanatory diagram for explaining calculation of availability time;

FIG. 13A is an explanatory diagram for explaining an example of availability time calculation for load monitoring processing;

FIG. 13B is an explanatory diagram for explaining an example of CPU idle ratio calculation for load monitoring processing;

FIG. 14 is a flowchart illustrating backup update processing;

FIG. 15 is an explanatory diagram for explaining backup update processing and backup update implementation processing;

FIG. 16 is a chart respectively illustrating examples of load for business processing, backup update processing, and overall processing when technology disclosed herein is applied;

FIG. 17 is a chart for explaining conventional operation of backup processing; and

FIG. 18 is a chart for explaining issues when performing a backup update during business processing in existing technology.

### DESCRIPTION OF EMBODIMENTS

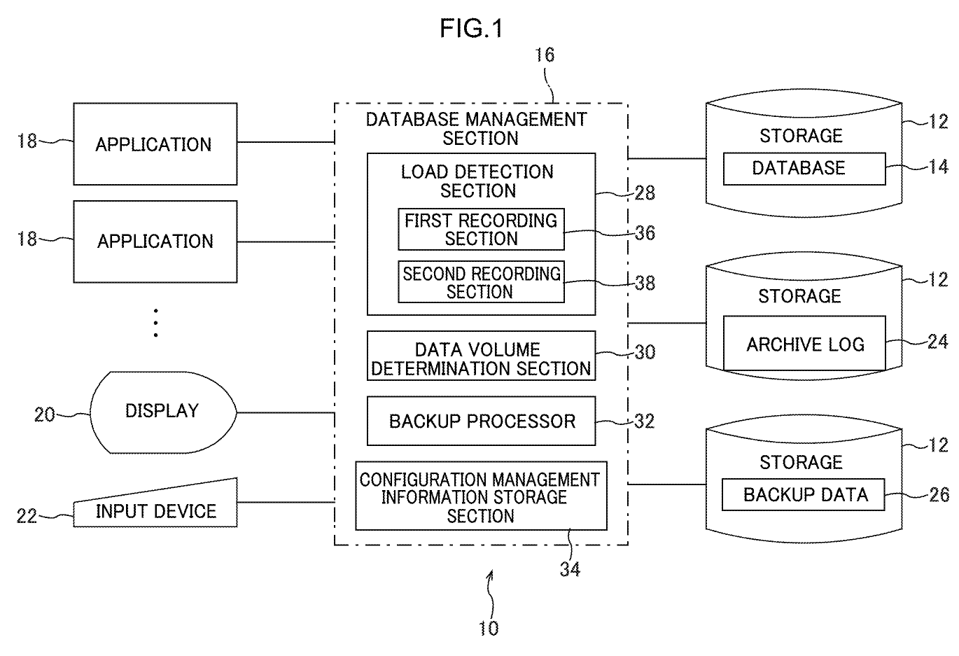

Detailed explanation follows regarding an example of an embodiment of technology disclosed herein, with reference to the drawings. FIG. 1 illustrates a database server (DB server) 10 according to the present exemplary embodiment. The DB server 10 is a device (server) that manages access to a database 14 stored in storage 12. The DB server 10 includes a database management section 16, an application 18, a display 20, an input device 22, and plural storages 12, including the storage 12 that stores the database 14.

The application 18 is an application that implements business processing, and instructs the database management section 16 to access to the database 14 by, for example, dispatching structured query language (SQL) or the like. Commands instructing access to the database 14, such as SQL format commands, are input to the input device 22 by a user. The database management section 16 performs processing that manages access to the database 14 accompanying instructions from the application 18 or from commands input from a user through the input device 22. The database management section 16 performs processing that stores incremental updates to data registered in the database 14, generated when accessing the database 14, in the storages 12 as an archive log 24.

Moreover, the storages 12 store a copy of data registered in the database 14 from a certain point in time, as backup data 26. The database management section 16 includes a load detection section 28, a data volume determination section 30, a backup processor 32, and a configuration management information storage section 34, for performing processing to update the backup data 26 when the archive log 24 has been updated.

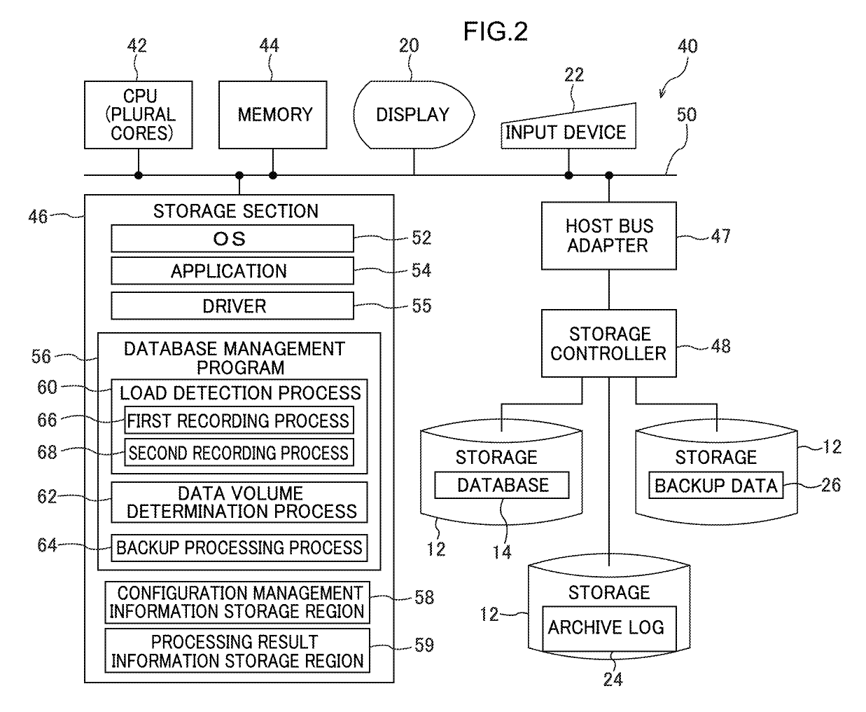

The load detection section 28 detects load on the DB server 10, which includes the storages 12. More precisely, the load detection section 28 includes a first recording section 36 and a second recording section 38. The first recording section 36 repeatedly detects load (I/O load) due to access to the storages 12, and records the detected I/O loads in a memory 44 (see FIG. 2) or the like. The second recording section 38 repeatedly detects load on a CPU (described later) of the DB server 10, and records the detected CPU loads in the memory 44 or the like.

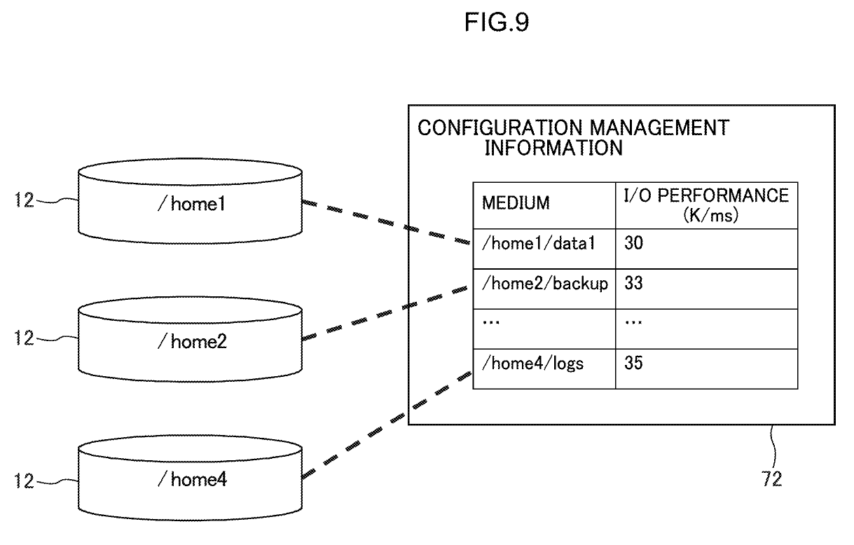

The data volume determination section 30 repeatedly determines data volumes subject to processing in backup processing to update the backup data 26, based on loads on the DB server 10, which includes the storages 12, detected by the load detection section 28. The backup processor 32 performs backup processing to update the backup data 26 with data of the data volume determined by the data volume determination section 30. The configuration management information storage section 34 stores configuration management information, which includes identification information for each of the plural storages 12 provided to the DB server 10, I/O performance information, or the like. An example of the configuration management information stored in the configuration management information storage section 34 is illustrated in FIG. 9.

The load detection section 28 is an example of a detection section of technology disclosed herein. The data volume determination section 30 is an example of a determination section of technology disclosed herein. The backup processor 32 is an example of a backup processor of technology disclosed herein. The configuration management information storage section 34 is an example of a storage section of technology disclosed herein. The first recording section 36 is an example of a first recording section of technology disclosed herein. The second recording section 38 is an example of a second recording section of technology disclosed herein.

The DB server 10 may be implemented by, for example, a computer 40 illustrated in FIG. 2. The computer 40 includes a CPU 42 provided with plural cores, a memory 44, a non-volatile storage section 46, a display 20, an input device 22 such as a keyboard or mouse, and a host bus adapter (HBA) 47. The CPU 42, the memory 44, the storage section 46, the display 20, the input device 22, and the host bus adapter 47 are connected to one another through a bus 50. The host bus adapter 47 is connected to a storage controller 48, and each of the plural storages 12 are connected to the storage controller 48.

Moreover, the storage section 46 may be implemented by a hard disk drive (HDD), flash memory, or the like. The storage section 46 stores an operating system (OS) program 52, a program 54 of the application 18, and a driver program 55. The storage section 46 also stores a database management program 56 for causing the computer 40 to function as the database management section 16 of the DB server 10, and is provided with a configuration management information storage region 58 and a processing result information storage region 59. The CPU 42 reads the database management program 56 from the storage section 46, expands the database management program 56 into the memory 44, and sequentially executes the processes included in the database management program 56.

The database management program 56 includes a load detection process 60, a data volume determination process 62, and a backup processing process 64. The CPU 42 operates as the load detection section 28 illustrated in FIG. 1 by executing the load detection process 60. The CPU 42 also operates as the data volume determination section 30 illustrated in FIG. 1 by executing the data volume determination process 62. The CPU 42 also operates as the backup processor 32 illustrated in FIG. 1 by executing the backup processing process 64. More precisely, the load detection process 60 includes a first recording process 66 and a second recording process 68. The CPU 42 operates as the first recording section 36 illustrated in FIG. 1 by executing the first recording process 66. The CPU 42 also operates as the second recording section 38 illustrated in FIG. 1 by executing the second recording process 68.

In cases in which the DB server 10 is implemented by the computer 40, the configuration management information storage region 58 functions as the configuration management information storage section 34 illustrated in FIG. 1. The computer 40, which executes the database management program 56, thereby functions as the DB server 10. The database management program 56 is an example of an information processing program of technology disclosed herein.

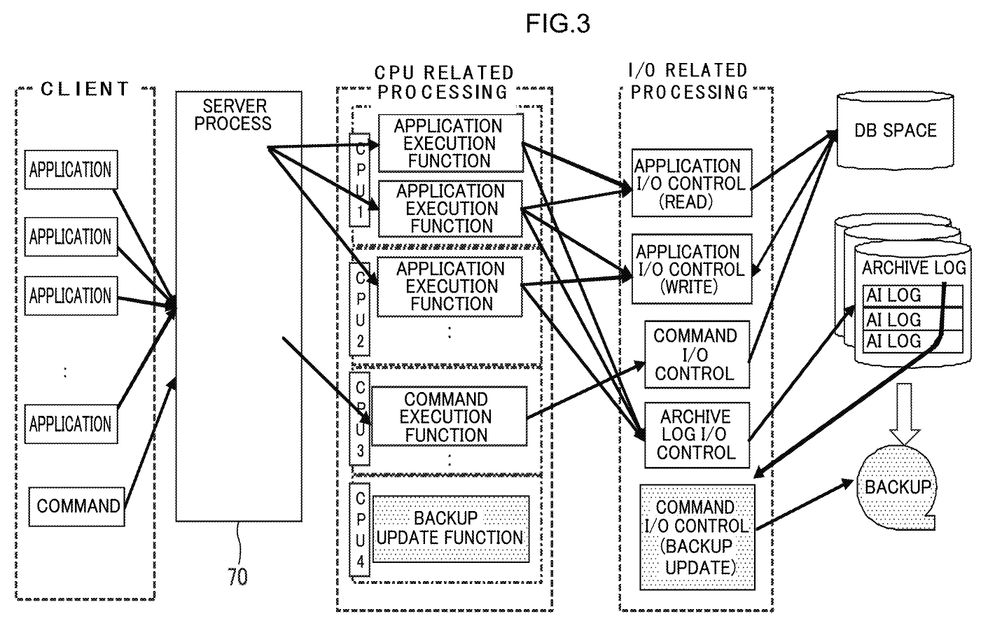

Explanation of operation of the present exemplary embodiment first follows regarding processing of access to the database 14 accompanying instructions of the application 18 or from commands input by a user, with reference to FIG. 3.

As illustrated in FIG. 3, instructions for access to the database 14, made by the application 18 or a command, are first input to a server process 70, and respective CPU processing processes are generated to implement the individual access instructions. Each individual generated CPU processing process is then allocated to a core of the CPU 42 for execution based on the utilization ratios of each of the plural cores provided to the CPU 42.

FIG. 3 illustrates an example in which CPU processing processes (labelled “application execution function” in FIG. 3) that implement instructions from the application 18 are allocated to a first core and a second core of the CPU 42 (respectively labelled “CPU1” and “CPU2” in FIG. 3) for execution. FIG. 3 also illustrates an example in which a CPU processing process (labelled “command execution function” in FIG. 3) that implements an access instruction according to a command is allocated to a third core of the CPU 42 (labelled “CPU3” in FIG. 3) for execution. Although FIG. 3 illustrates an example in which four cores are provided to the CPU 42, the number of cores provided to the CPU 42 is not limited to four.

Moreover, as illustrated in FIG. 3, as a result of executing each CPU processing process in a core of the CPU 42, I/O requests requesting access to the database 14 (“application I/O control” and “command I/O control” in FIG. 3) are respectively generated by a driver. When the data of the database 14 is updated accompanying execution of an I/O control process that performs access to the database 14, an I/O request requesting an update to the archive log 24 (“archive log I/O control” in FIG. 3) is also generated by the driver.

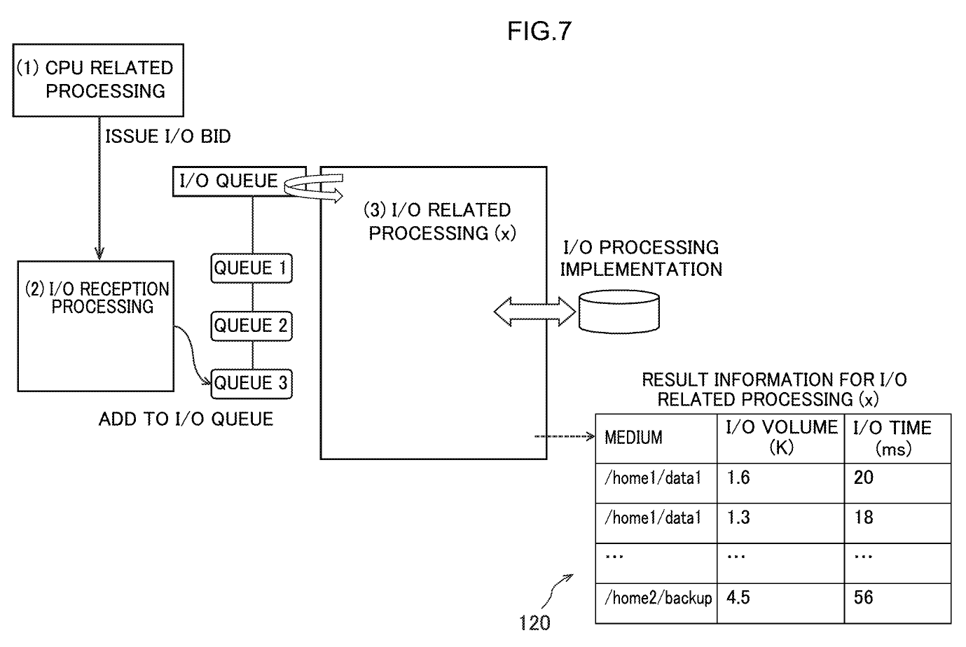

The driver is provided with plural I/O queues (see FIG. 7) for holding I/O requests, and I/O requests generated according to requests from CPU processing are temporarily inserted into one of the I/O queues. The driver causes the storage 12 (the database 14 or the archive log 24) to be accessed by reading the I/O requests held by the individual queues from the I/O queues in the order that they were inserted into the I/O queues, and forwarding/inputting the I/O requests to the corresponding HBA 47. The I/O requests forwarded from the driver to the HBA 47 are forwarded to the storage controller 48, and, after access (reading/writing) has been made to the storage 12 (the database 14 or the archive log 24) corresponding to the I/O request, a response to the I/O request is forwarded.

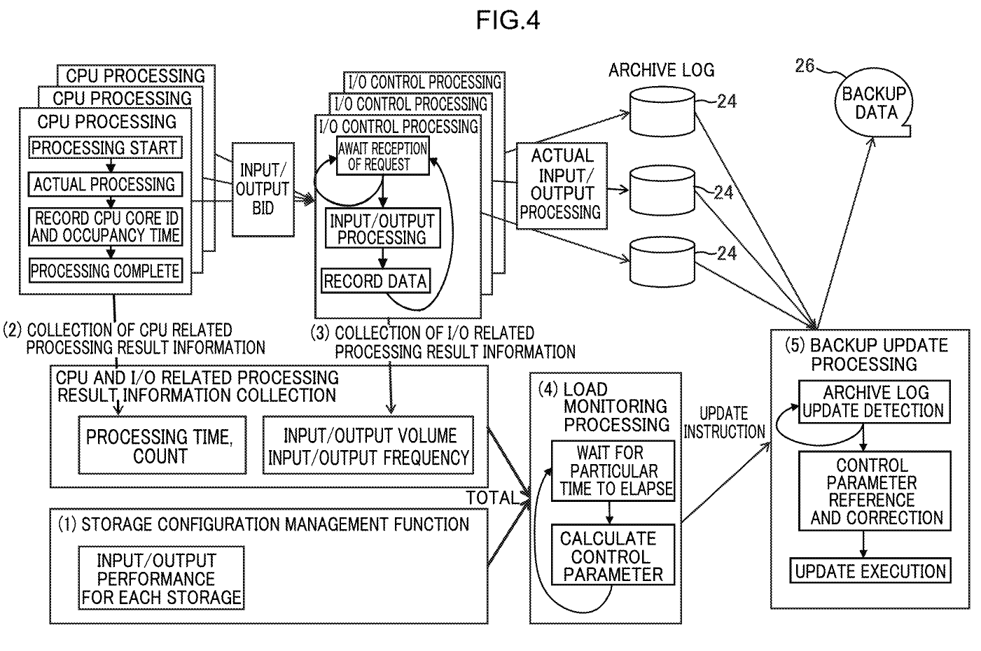

Next, explanation follows regarding processing to update the backup data 26 of the present exemplary embodiment (backup update processing). As illustrated in FIG. 4, the backup update processing includes (1) storage 12 configuration management, (2) collection of CPU 42 processing result information, (3) collection of I/O processing result information, (4) load monitoring processing, and (5) backup update processing.

Of these, “(1) storage 12 configuration management” is implemented by storing respective configuration management information 72 of the plural storages 12 in the configuration management information storage section 34 (see FIG. 9). As illustrated in FIG. 9, for each of the individual storages of the DB server 10, the configuration management information 72 includes identification information of the individual storage 12, and information indicating I/O performance.

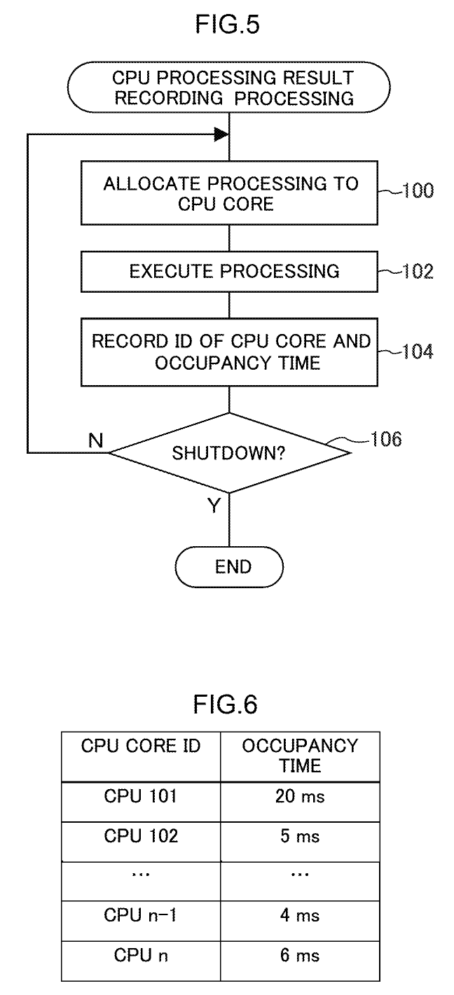

Moreover, “(2) collection of CPU 42 processing result information” is implemented by the core ID and occupancy time of the CPU 42 being recorded in the processing result information storage region 59 by the second recording section 38 of the load detection section 28 each time a CPU processing process is executed by an individual core of the CPU 42. More precisely, the CPU processing result recording processing illustrated in FIG. 5 is implemented by a respective core of the CPU 42 executing the CPU processing process.

At step 100, the CPU processing result recording processing, processing is allocated to one of the cores of the CPU 42, and at step 102, the actual processing is performed. When execution of the processing allocated to one of the cores of the CPU 42 has completed, at the next step 104, the second recording section 38 records, in the processing result information storage region 59, the ID of the core of the CPU 42 that completed execution of the processing, and the core occupancy time for the processing that has completed execution. Thus, as the example of CPU processing result information 108 in FIG. 6 illustrates, the time for which the individual core of the CPU 42 was occupied is recorded in the processing result information storage region 59 in association with the ID of the individual core. At the next step 106, the computer 40 determines whether or not there is to be a shutdown, and in cases in which negative determination was made at step 106, processing returns to step 100 and step 100 and onwards are repeated. The CPU processing result recording processing ends in cases in which affirmative determination has been made at step 106.

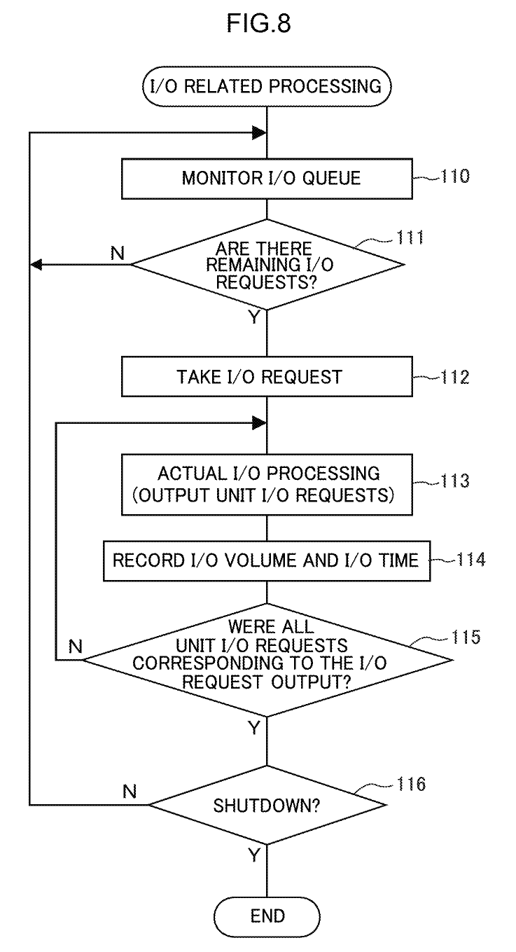

Moreover, “(3) collection of I/O processing result information” illustrated in FIG. 4 is implemented by the processing illustrated in FIG. 7. Namely, the driver performs processing to generate an I/O request and inserts the generated I/O request inserted into an I/O queue (I/O reception processing in FIG. 7) each time access to the storage 12 is requested (“I/O bid dispatch” in FIG. 7) accompanying execution of CPU processing processes by respective cores of the CPU 42. The driver also performs the ordinary execution of I/O related processing illustrated in FIG. 7. FIG. 8 illustrates details of I/O related processing. The I/O related processing by the driver illustrated in FIG. 8 is independently executed in each core of the CPU 42.

At step 110 of the I/O related processing, the driver monitors the I/O queue, and at the next step 111, the driver determines whether or not any I/O requests remain in the I/O queue. In cases in which there are no I/O requests remaining in the I/O queue, negative determination is made at step 111, processing returns to step 110, and step 110 and step 111 are repeated. In cases in which there are I/O requests remaining in the I/O queue, affirmative determination is made at step 111, processing transitions to step 112, and at step 112, the driver takes an I/O request that remains in the I/O queue. At the next step 113, in response to the I/O request taken from the I/O queue, the driver forwards/inputs, to the HBA 47, a unit I/O request requesting I/O of a particular size, and performs the actual I/O processing.

At the next step 114, the first recording section 36 of the load detection section 28 records the ID of the storage 12 targeted for access, the I/O data volume, and the access time (an I/O time spanning from when the unit I/O request was forwarded until a response was received) in the processing result information storage region 59. At step 115, the driver determines whether or not all of the unit I/O requests corresponding to the I/O request taken from the I/O queue at step 112 have been output. In cases in which negative determination has been made at step 115, processing returns to step 113, and step 113 to step 115 are repeated until affirmative determination is made at step 115.

All of the unit I/O requests corresponding to the I/O request taken from the I/O queue at step 112 are thereby forwarded to the HBA 47. As the example of I/O processing result information 120 in FIG. 7 illustrates, the ID of the storage 12 that has been accessed, the I/O data volume, and the access time (I/O time) are recorded in the processing result information storage region 59 for each respective core of the CPU 42.

When all of the unit I/O requests corresponding to the I/O request taken from the I/O queue at step 112 have been forwarded to the HBA 47, affirmative determination is made at step 115, processing transitions to step 116, and at step 116, the driver determines whether or not the computer 40 is to be shutdown. When negative determination has been made at step 116, processing returns to step 110, and the driver resumes monitoring the I/O queue.

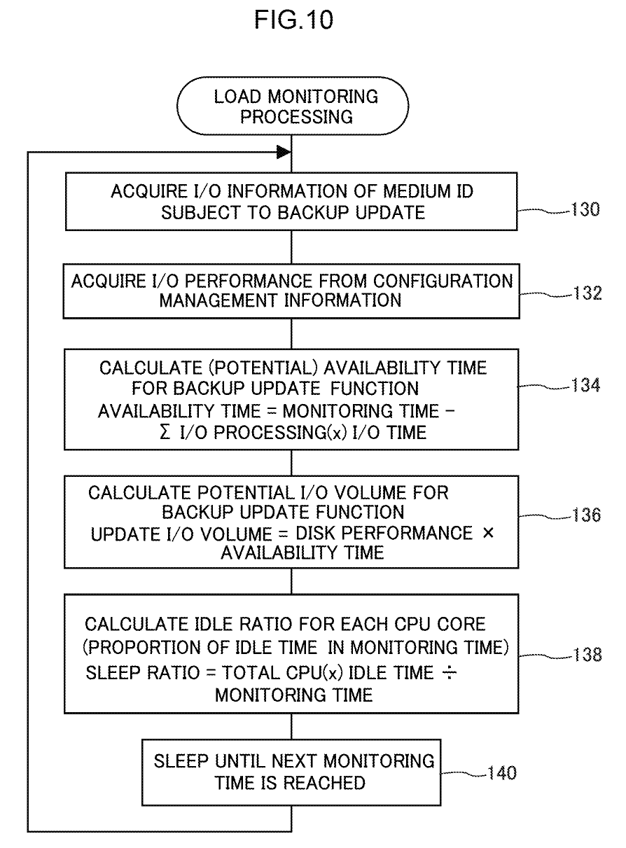

Next, explanation follows regarding details of “(4) load monitoring processing” illustrated in FIG. 4, with reference to FIG. 10. The load monitoring processing is implemented by the data volume determination section 30, and is executed every particular time interval on one of the cores of the CPU 42. For example, FIG. 3 illustrates an example in which a CPU processing process, which implements a backup update function (labelled “backup update function” in FIG. 3), has been allocated to the fourth core of the CPU 42 (labelled “CPU4” in FIG. 3) and executed.

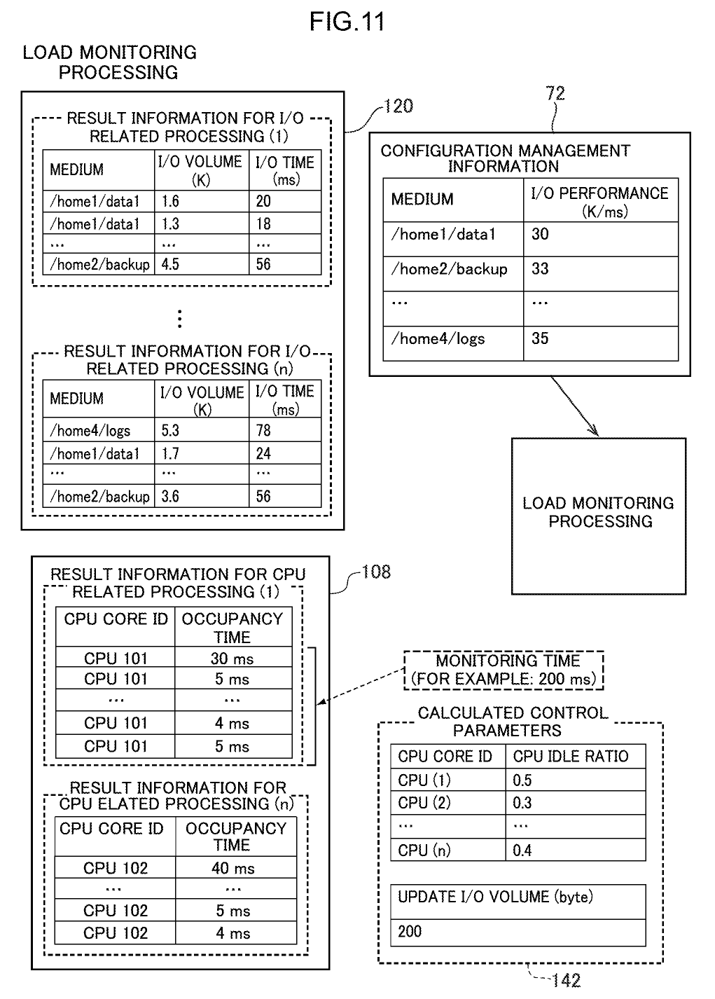

At step 130 of the load monitoring processing, the data volume determination section 30 acquires the I/O processing result information 120 appended with the ID of the storage 12 on which the backup update processing is to be performed (an example is illustrated in FIG. 11), from the I/O processing result information 120 stored in the processing result information storage region 59. At the next step 132, the data volume determination section 30 acquires the configuration management information 72 of the storage 12 on which the backup update processing is to be performed (an example is illustrated in FIG. 11), from the configuration management information storage region 58.

At the next step 134, the data volume determination section 30 calculates the availability time that can be allocated to the backup update processing according to Equation (1) below, based on the information acquired at step 130.

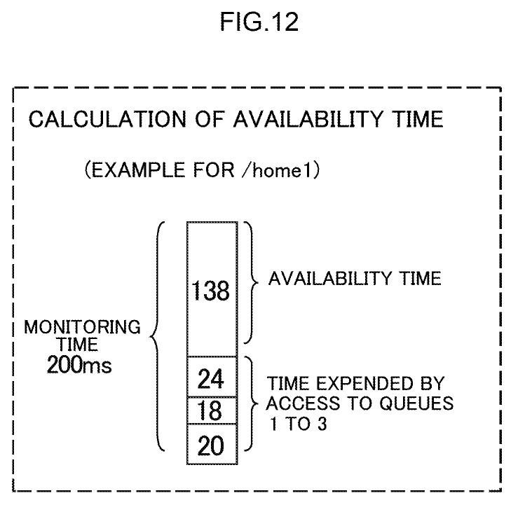

Availability time=T0−Σt_{I/O}(x) (1)

Where T0 is the execution cycle of the load monitoring processing, and t_{I/O}(x) is the access time (I/O) time each time the storage 12 on which the backup update processing is to be performed is accessed. For example, the example illustrated in FIG. 12 and labelled “calculation of availability time” illustrates an example in which the load monitoring processing execution cycle (monitoring cycle) T0=200 ms, the number of accesses from the previous execution of the load monitoring processing onwards is 3, and the access times are 20 ms, 18 ms, and 24 ms, respectively. In this case, availability time=200−(20+18+24)=138 ms.

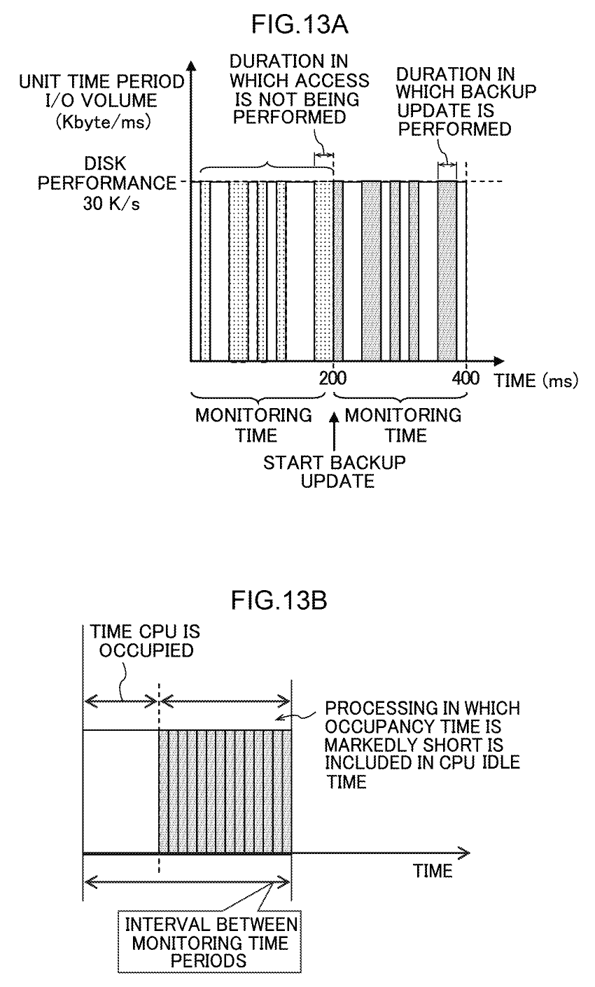

FIG. 13A illustrates an example of transitioning to accessing the storage 12 for two cycles worth of time (one cycle worth of time=the monitoring time illustrated in FIG. 13A) of the execution cycles of the load monitoring processing. In FIG. 13A, the duration the storage 12 was accessed in out of the duration the first cycle of the execution cycles of the load monitoring processing is indicated by areas filled in white, and the duration the storage 12 was not accessed in is indicated by shading. Equation (1) above calculates, as the availability time, the total time of the durations indicated by the shading, in which the storage 12 is not accessed (time in which there is potentially spare I/O capacity), from out of the duration of the first cycle of the execution cycles of the load monitoring processing.

The above availability time is an example of “spare capacity of load of access to the storage” of technology disclosed herein. The above processing is able to accurately find the spare capacity of load of access to the storage 12.

At the next step 136, the data volume determination section 30 calculates a processing target data volume of the backup update processing based on the availability time that can be allocated to the backup update processing calculated at step 134. Note that the processing target data volume of the backup update processing can be calculated by multiplying the availability time that can be allocated to the backup update processing by the I/O performance of the storage 12 acquired at step 132. The calculated processing target data volume of the backup update processing is stored in the memory 44. The above processing target data volume is an example of a “data volume of the backup processing corresponding to the spare capacity of the load of access to the storage” of technology disclosed herein.

In the backup update processing, when backing up of data of the processing target data volume calculated at step 136 has been performed, ordinary access to the storage 12 is performed, as illustrated for the duration of the second cycle of the execution cycles of the load monitoring processing in FIG. 13A. Accordingly, the load of access to the storage 12 becomes excessive, and it is possible that this may have a negative impact on business processing, such processing delays. Since the above processing target data volume is found without considering the load on the CPU 42, it is possible that the load on the CPU 42 may become excessive. The load on the CPU 42 is therefore also considered in the present exemplary embodiment as described below, and the processing target data volume of the backup update processing calculated at step 136 is corrected.

At the next step 138, the data volume determination section 30 acquires the CPU processing result information 108 for each respective core of the CPU 42 from the processing result information storage region 59 (an example is illustrated in FIG. 11). The idle ratio (the reciprocal of a utilization ratio) of each respective core of the CPU 42 is also calculated according to Equation (2) below, based on the acquired CPU processing result information 108.

idle ratio=Σt_{idle}(x)÷T0 (2)

Where T0 is the execution cycle of the load monitoring processing, and t_{idle}(x) is the standby time of a core x. Although the time for which the core of the CPU 42 is occupied is recorded in the CPU processing result information 108, a duration in which there are consecutive markedly short occupancy times is regarded as a standby state of the core of the CPU 42 (see also FIG. 13B), and the idle ratio is calculated with the occupancy time of this duration included in the standby time. The idle ratio calculated for each respective core of the CPU 42 is stored in the memory 44.

At the next step 140, the data volume determination section 30 stands by until a next execution timing of the load monitoring processing is reached, and processing returns to step 130 when the execution timing is reached. The above load monitoring processing causes a control parameter 142 for the backup update processing (the processing target data volume and the idle ratio for each respective core of the CPU 42; see FIG. 11) to be stored in the memory 44, and updates the value of the control parameter 142 for each execution cycle TO of the load monitoring processing.

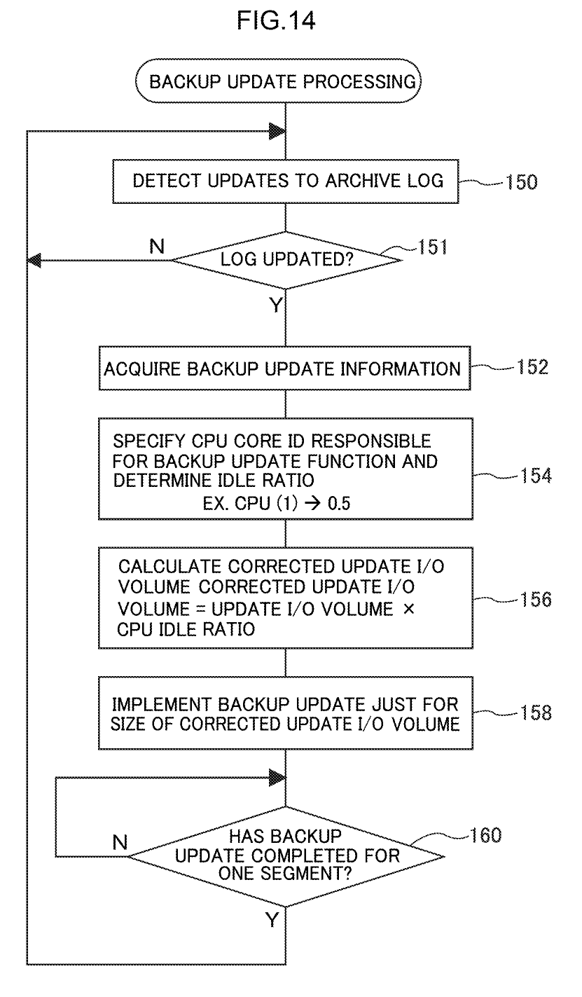

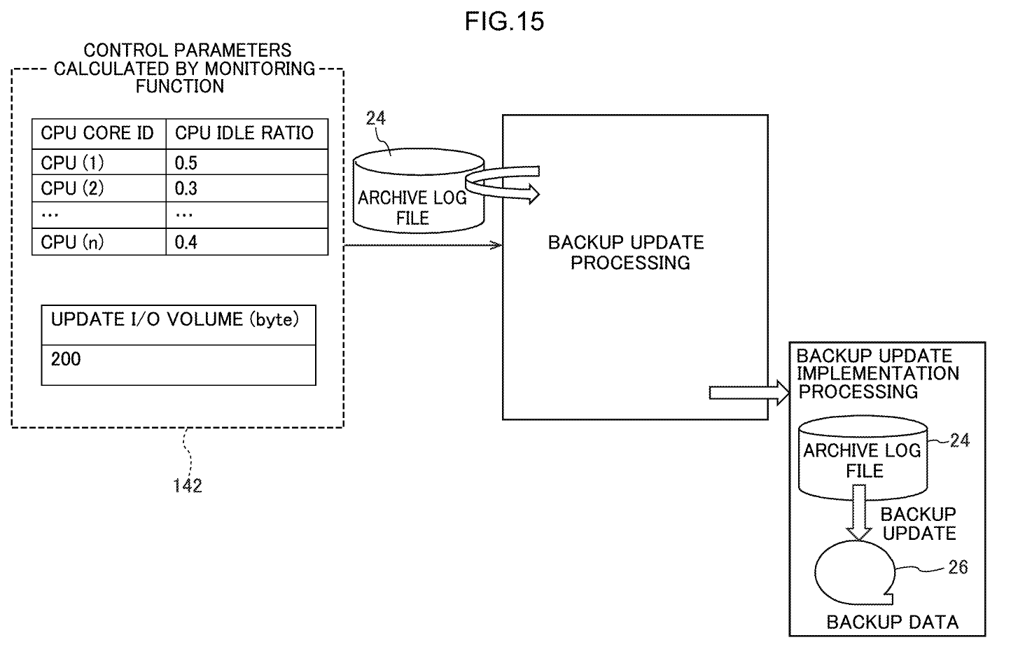

Next, explanation follows regarding details of “(5) backup update processing” illustrated in FIG. 4, with reference to FIG. 14 and FIG. 15. The backup update processing is implemented by the data volume determination section 30 and the backup processor 32, and is executed every particular time interval on one of the cores of the CPU 42, similarly to the load monitoring processing. FIG. 3 illustrates an example in which a CPU processing process that implements a backup update function (labelled “backup update function” in FIG. 3) has been allocated to the fourth core of the CPU 42 (labelled “CPU4” in FIG. 3) and executed.

At step 150 of the backup update processing, the backup processor 32 detects the presence or absence of an update to the archive log 24, and at the next step 151, the backup processor 32 determines whether or not the archive log 24 has been updated. In cases in which the archive log 24 has not been updated, negative determination is made at step 151, processing returns to step 150, and step 150 and step 151 are repeated. In cases in which the archive log 24 has been updated, affirmative determination is made at step 151, processing transitions to step 152, and at step 152, the data volume determination section 30 acquires backup update information (the control parameter 142; see FIG. 15) from the memory 44.

At the next step 154, the data volume determination section 30 specifies the core on which backup update implementation processing is to be performed based on the idle ratio of each respective core of the CPU 42 included in the acquired control parameter 142. The core having the greatest idle ratio out each respective core of the CPU 42 included in the acquired control parameter 142 may be employed as the core on which to perform the backup update implementation processing.

At the next step 156, the data volume determination section 30 corrects the processing target data volume of the backup update processing included in the acquired control parameter 142 according to Equation (3), based on the idle ratio of the core specified at step 154.

post-correction processing target data volume=pre-correction processing target data volume×core idle ratio (3)

According to Equation (3) above, the post-correction processing target data volume decreases as the idle ratio of the core on which to perform the backup update implementation processing decreases. This enables the load of access to the storage 12, and the load on the core on which the backup update implementation processing is to be performed, to be suppressed from becoming excessive, and enables negative impacts on business processing, such processing delays, to be suppressed.

At the next step 158, the backup processor 32 performs the backup update implementation processing illustrated in FIG. 15 for just the post-correction processing target data volume, using the core specified at step 154. The backup data 26 is thereby updated by additionally storing, in the backup data 26, just the post-correction processing target data volume for the update data of the archive log 24 (data corresponding to the incremental update to the database 14). When the backup update implementation processing is performed, at the next step 160, the backup processor 32 determines whether or not one segment of the backup update has completed. The determination of step 160 is repeated while the determination of step 160 is negative. In cases in which affirmative determination is made at step 160, processing returns to step 150, and the backup processor 32 resumes the processing to detect the presence or absence of updates to the archive log 24.

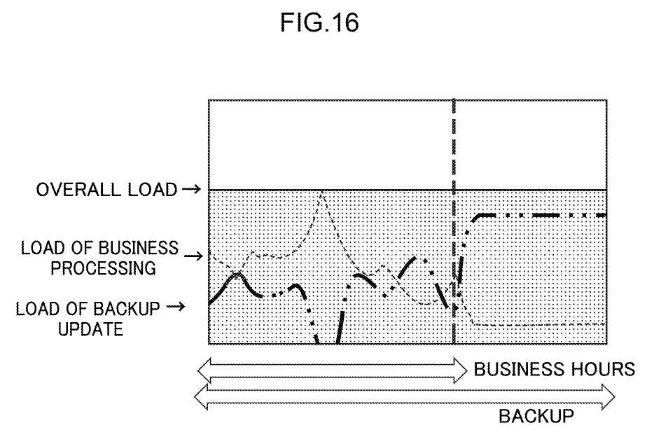

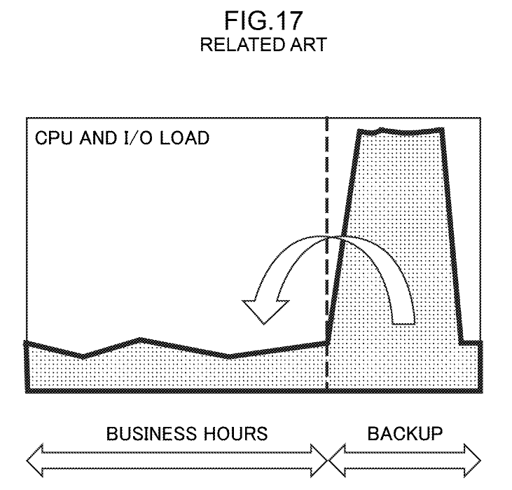

As described above, in the present exemplary embodiment, in parallel with business processing, load of access to the storage 12 and load on the respective cores of the CPU 42 are detected, the processing target data volume is determined based on the detected loads, and the backup update is performed. The total load is evened out by adjusting the processing target data volume of the backup update as illustrated by the dot dashed line in FIG. 16, even in cases in which, for example, the load accompanying execution of business processing fluctuates as illustrated by the dashed line in FIG. 16. Accordingly, backup update can be performed continuously while suppressing negative impacts on business processing due to the load of access to the storage 12 or the load on the respective cores of the CPU 42 becoming excessive, even in an environment in which the load accompanying execution of business processing is comparatively high.

Moreover, enabling backup update to be performed in parallel with business processing obviates any need to perform operations such as backup updates over a duration in which execution of business processing is suspended, such as at night.

Although explanation has been given above regarding an embodiment in which the DB server 10 is employed as an example of an information processing device according to technology disclosed herein, there is no limitation thereto, and a web server, application server, personal computer, or the like may also be employed.

Although explanation has been given above regarding a configuration in which the CPU 42 is provided with plural cores, there is no limitation thereto, and the CPU may be configured so as to be provided with a single core. Although explanation has been given above regarding a configuration in which plural storages 12 are provided, there is no limitation thereto, and application may also be made to a configuration in which a single storage is provided.

Explanation has been given above regarding embodiments in which the database management program 56, which is an example of an information processing program according to technology disclosed herein, is pre-stored (installed) in the storage section 46 of the DB server 10. However, technology disclosed herein is not limited to this embodiment, and an embodiment in which an information processing program according to technology disclosed herein is recorded on a recording medium such as a CD-ROM or DVD-ROM may also be provided.

All cited documents, patent applications and technical standards mentioned in the present specification are incorporated by reference in the present specification to the same extent as if each individual cited document, patent application, or technical standard was specifically and individually indicated to be incorporated by reference.

The first technology suspends backup processing in cases in which it is inferred that work has been resumed by an operator, such that, in order to complete backup processing, there is a need to perform the backup processing in a time period when operations are not being input by the operator, such as at night. Accordingly, there is an issue in that the time period in which execution is possible is restricted by business processing that includes operation input by the operator.

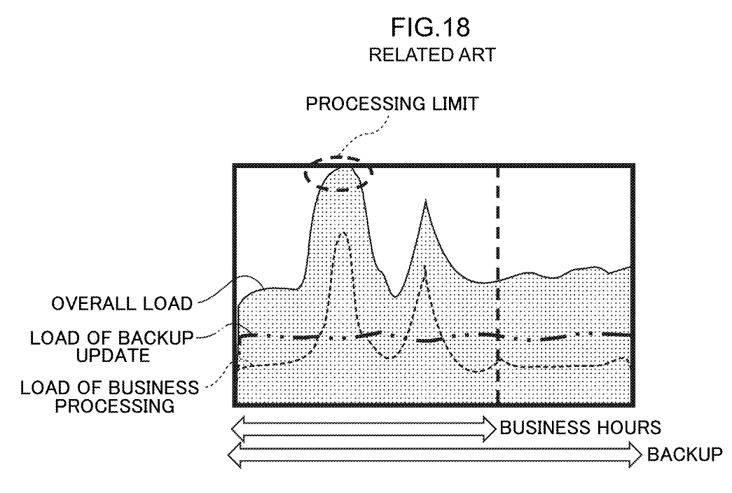

In the second technology, data access loads are monitored, and the time period for backup processing is not restricted since the backup processing is performed in a duration when data access load is low. However, a high load is also placed on the CPU when performing backup processing. To address this, the second technology performs backup processing during a particular time period as long as the data access load is low, and there is accordingly the possibility, as the example in FIG. 18 illustrates, that due to the load placed on the CPU accompanying backup processing becoming excessive, a processing limit might be reached. Thus, due to the load placed on the CPU is not being considered, there is a possibility of impact on business processing, such as processing delays, occurring in the second technology due to the load placed on the CPU becoming excessive.

In the second technology, due to the backup processing being performed during a particular time period as long as the data access load is low, and irrespective of the magnitude of the data access load, this leads to a possibility of the data access load or the CPU load becoming excessive while performing backup processing. In such cases also, there is an impact to business processing, such processing delays, due to adopting a state in which the processing limit is reached, or processing is close to the limit, as the example in FIG. 18 illustrates.

One aspect enables backup processing to be performed in parallel with execution of business processing while suppressing impact on business processing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a backup control program that causes a computer to execute a process comprising:
detecting storage access load and processor load of a target computer, the storage access load being a load of access to a storage of the target computer, and the processor load being a load on a target processor of the target computer;
determining a data volume of backup processing based on the storage access load and the processor load, the backup processing accompanying access to the storage and operation of the target processor; and
performing the backup processing based on the data volume.

2. The recording medium according to claim 1, wherein
the determining determines the data volume of backup processing based on spare capacity of the storage and an idle ratio of the target processor, the spare capacity of the storage being calculated from the storage access load, and the idle ratio of the target processor being calculated from the target processor load.

3. The recording medium of claim 1, wherein
the detecting detects the storage access load of the target computer by recording a number of times that access to the storage occurred within a unit time period, and a time taken for each individual access, and by detecting a total value of the time taken for the individual accesses to the storage that occurred within the unit time period as the load of access to the storage of the target computer within the unit time period.

4. The recording medium of claim 2, wherein:
the detecting detects the storage access load of the target computer by recording a number of times access to the storage occurred within a unit time period, and a time taken for each individual access, and by detecting a total value of the time taken for the individual accesses to the storage that occurred within the unit time period as the load of access to the storage of the target computer within the unit time period; and
the spare capacity of the storage is calculated as an availability time that is the total value of the time taken for the individual accesses to the storage that occurred within the unit time period subtracted from the unit time period.

5. The recording medium of claim 4, wherein:
the data volume of the backup processing corresponding to the spare capacity of the storage is calculated by multiplying the availability time calculated as the spare capacity of the storage, by the data volume accessible per unit time period expressed in access performance information that is stored in a first storage section and that indicates a data volume accessible per unit time period with respect to the storage.

6. The recording medium of claim 1, wherein:
the detecting further comprises recording a number of times, and a particular time, that the target processor is occupied within a unit time period, in a second storage section, and
the detecting detects the processor load based on a total value of time that the target processor is occupied within the unit time period.

7. The recording medium of claim 1, wherein:
the detecting the storage access load and the processor load of the target computer includes processing to update a database stored on first storage; and
the backup processing includes processing that stores incremental updates to the database on second storage.

8. An information processing device comprising:
a memory; and
a processor configured to execute a procedure, the procedure including:
detecting storage access load and processor load of a target computer, the storage access load being a load of access to a storage of the target computer, and the processor load being a load on a target processor of the target computer;
determining a data volume of backup processing based on the storage access load and the processor load, the backup processing accompanying access to the storage and operation of the target processor; and
performing the backup processing based on the data volume.

9. The information processing device of claim 8, wherein
the determining determines the data volume of backup processing based on spare capacity of the storage and an idle ratio of the target processor, the spare capacity of the storage being calculated from the storage access load, and the idle ratio of the target processor being calculated from the target processor load.

10. The information processing device of claim 8, wherein
the detecting detects the storage access load of the target computer by recording a number of times that access to the storage occurred within a unit time period, and a time taken for each individual access, and by detecting a total value of the time taken for the individual accesses to the storage that occurred within the unit time period as the load of access to the storage of the target computer within the unit time period.

11. The information processing device of claim 8, wherein the detecting further comprises:
recording a number of times, and a particular time, that the target processor is occupied within a unit time period, and
detecting the processor load based on a total value of time that the target processor is occupied within the unit time period accompanying execution of the processing.

12. The information processing device of claim 8, wherein:
the detecting the storage access load and the processor load of the target computer includes processing to update a database stored on first storage; and
the backup processing includes processing that stores incremental updates to the database on second storage.

13. An information processing method comprising:
by a processor:
detecting storage access load and processor load of a target computer, the storage access load being a load of access to a storage of the target computer, and the processor load being a load on a target processor of the target computer;
determining a data volume of backup processing based on the storage access load and the processor load, the backup processing accompanying access to the storage and operation of the target processor; and
performing the backup processing based on the data volume.

14. The information processing method of claim 13, wherein
the determining determines the data volume of backup processing based on spare capacity of the storage and an idle ratio of the target processor, the spare capacity of the storage being calculated from the storage access load, and the idle ratio of the target processor being calculated from the target processor load.

15. The information processing method of claim 13, wherein
the detecting detects the storage access load of the target computer by recording a number of times that access to the storage occurred within a unit time period, and a time taken for each individual access, and by detecting a total value of the time taken for the individual accesses to the storage that occurred within the unit time period as the load of access to the storage of the target computer within the unit time period.

16. The information processing method of claim 13, wherein the detecting further comprises:
recording a number of times, and a particular time, that the target processor is occupied within a unit time period, and
detecting the processor load based on a total value of time that the target processor is occupied within the unit time period accompanying execution of the processing.

17. The information processing method of claim 13, wherein:
the detecting the storage access load and the processor load of the target computer includes processing to update a database stored on first storage; and
the backup processing includes processing that stores incremental updates to the database on second storage.
